(19) United States
(12) Patent Application Publication
(10) Pub. No.: US 2004/0213940 A1
(43) Pub. Date: Oct. 28, 2004

(54) Methods and apparatus for laminating documents

(76) Inventor: Kenneth Ian Greenhill, Milford, CT (US)

Correspondence Address: GREER, BURNS & CRAIN, 300 S WACKER DR, 25TH FLOOR, CHICAGO, IL, 60606, US

(21) Appl. No.: 10/719,769

(22) Filed: Nov. 21, 2003

Related U.S. Application Data
(63) Continuation-in-part of application No. 10/457,310, filed on Jun. 9, 2003.
(60) Provisional application No. 60/465,405, filed on Apr. 24, 2003.

(51) Int. Cl. B32B 9/00

(52) U.S. Cl. 428/40.1

(57) ABSTRACT

A substrate of label stock or the like has pressure sensitive adhesive on one side, covered by release material. The release material is folded back or removed along one edge of the substrate, exposing the pressure sensitive adhesive along that edge. A transparent laminate is secured to the substrate by the exposed pressure sensitive adhesive. A photograph of other document can be secured inside the device by lifting the unadhered portion of the laminate, placing the photograph between the laminate and the substrate, removing the release layer to expose the remainder of the pressure sensitive adhesive layer, and pressing the photograph and laminate against the lower substrate. The photograph is preferably smaller than the laminate product, so that the laminate is secured to the substrate around all edges of the photograph. One or more legs can be provided for positioning the device in an upright position.

This is a Continuation-in-part of application Ser. No. 10/457,310 filed on Jun. 9, 2003, which claims priority from Provisional Application Ser. No. 60/465,405, filed on Apr. 24, 2003.

This invention relates to methods and apparatus for laminating documents, and more particularly, to methods and apparatus for laminating photographs without lamination equipment.

### BACKGROUND OF THE INVENTION

Documents such as driver's licenses and security badges are routinely provided with a second substrate, preferably transparent laminate, to protect the documents from damaging environmental conditions such as moisture. The document is placed in a lamination machine that heats the second substrate surface as needed, applies the preferably transparent laminate material to the documents and trims the material. The process is effective, but the lamination machine is expensive and inconvenient. Thus, there is a need for lamination methods and apparatus that do not require such lamination equipment.

Accordingly, one object of this invention is to provide new and improved methods and apparatus for laminating documents.

Another object is to provide new and improved methods and apparatus for laminating documents that do not require lamination equipment for applying the lamination to the document.

Still another object is to provide new and improved methods and apparatus for conveniently and inexpensively laminating documents.

### SUMMARY OF THE INVENTION

In keeping with one aspect of the invention, a substrate of label stock or the like has pressure sensitive material on one side, covered by release material. A portion of the release material is folded back along one edge of the substrate, exposing the pressure sensitive adhesive along that edge and thus creating a pull tab. A transparent laminate is secured to the substrate along that edge by the exposed pressure sensitive adhesive. The transparent film and/or pressure sensitive material can be printed, if desired, particularly around the outside edges.

A photograph or other document can be secured inside the device by lifting the unadhered portion of the laminate that covers the release material, placing the photograph between the film lamination and the pressure sensitive substrate above the tab, removing the release layer by pulling the tab outward to expose the remainder of the pressure sensitive adhesive layer, and pressing the photograph and laminate against the lower substrate. The photograph can be smaller than the laminate product, so that the lamination is secured to the base substrate around all of its outer edges.

The lamination product is made by moving a web of pressure sensitive adhesive material, having release material on one side, along a path that may include one or more printing stations, if desired. The release material may be perforated, scored or optionally slit to allow the release layer to be folded back after a conventional plough station. The folded back portion of the release liner exposes the pressure sensitive adhesive along an edge of the web.

A web of the second substrate, preferably transparent laminate material, which may also be printed on either or both sides, is married to the underlying web after the release layer is exposed, and secured to the web along the exposed edge of pressure-sensitive adhesive. The web is then die cut into individual pieces having a desired size.

Another embodiment of the lamination product has a support structure including at least one leg defined by at least one perforated line that the leg can be separated and positioned to support the product upright on a table or the like.

Yet another embodiment of the lamination product includes a support structure having a leg defined by at least one cut line such that the leg can be positioned to support the product upright on a table or the like.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cut-away side view of a lamination product made in accordance with the present invention;

FIG. 2 is a cut-away side view of the product of FIG. 1, showing a photograph inserted in the assembly, but not secured;

FIG. 3 is another cut-away side view of the product of FIG. 1, showing the release liner being removed from the product after the photo is inserted;

FIG. 4 is a cut-away side view of the product of FIG. 1, showing the lamination secured;

FIG. 5 is front perspective view of the lamination device of FIG. 1, as manufactured;

FIG. 6 is a front perspective view of FIG. 5 showing a photograph inserted in the product;

FIG. 7 is a front perspective view of the lamination product of FIG. 5, showing the release liner as it is removed;

FIG. 8 is a front perspective view of the product of FIG. 5, with the photograph secured inside the product;

FIG. 9 is a diagram illustrating the manufacturing process used to make the product of FIG. 1;

FIG. 10 is a front perspective view of an alternate embodiment of the lamination device, as manufactured;

FIG. 11 is a front perspective view of the product of FIG. 10 showing a photograph inserted in the product and the release liner as it is removed;

FIG. 12 is a back perspective view of the product of FIG. 10 showing the perforation of the legs;

FIG. 13 is a front perspective view of the product of FIG. 10 showing the legs detached and supporting the device.

FIG. 14 is a front perspective view of another alternate embodiment of the lamination device, as manufactured;

FIG. 15 is a front perspective view of the product of FIG. 14 showing the release liner as it is removed;

FIG. 16 is a back perspective view of the product of FIG. 14 showing the die-cut of the leg; and

FIG. 17 is a front perspective view of the product of FIG. 14 showing a photograph inserted and the leg detached and supporting the device.

### DETAILED DESCRIPTION

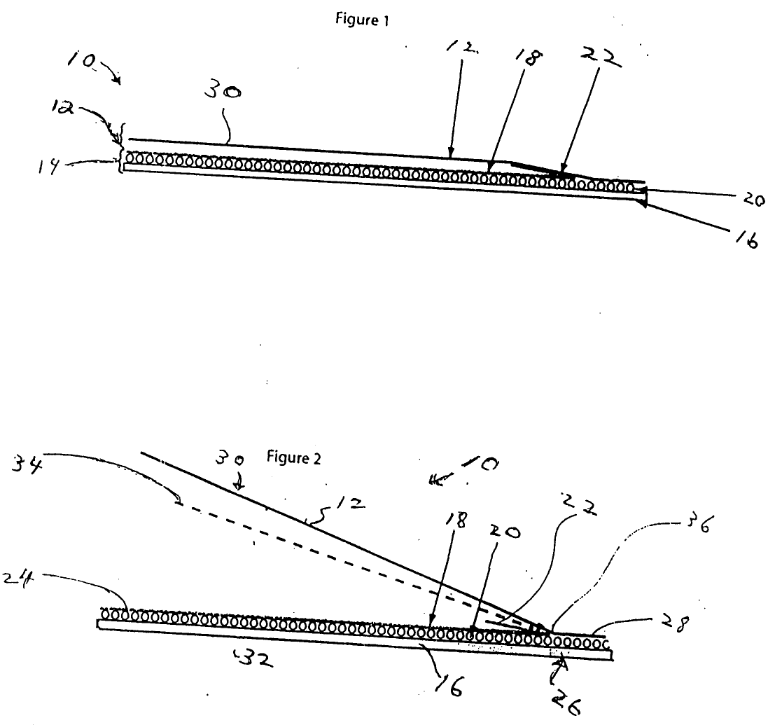

As seen in FIG. 1, a lamination product 10 includes a layer 12 of unsupported film that can be print receptive on both sides, and a layer 14 that includes a layer 16 of paper or film, releasably adhered to a layer of paper or film 18, through a pressure sensitive adhesive 20. The film can be clear or tinted film substrate, typically a laminate, and the release layer 18 is ordinary release liner used for pressure sensitive adhesive labels. Adhesive layer 20 can be any suitable pressure sensitive or other suitable adhesive, and the substrate 16 can be label stock or any other suitable material.

As seen in FIG. 2, a portion 22 of the release layer 18 is folded over a larger portion 24, which exposes a portion 26 of the adhesive on the base substrate 16, so that an edge portion 28 of the laminate 12 is directly adhered to the portion 26 of the substrate 16. In this manner, a hinge 36 is formed in the laminate 12.

A portion 30 of the laminate 12 is not adhered to a portion 32 of the substrate 16, due to the intervening release layer 24. In this manner, the portion 30 can be lifted from the portion 32 to insert a photograph 34 other document into the device 10 above the tab 22 created by the folded section of the release layer 18.

Preferably, the photograph 34 is smaller in size than the portion 32, so that the outside edges of the adhesive in the portion 32 can contact the underside of the portion 30 when the release liner 24 is removed, although extra space is not necessary at the hinge 36.

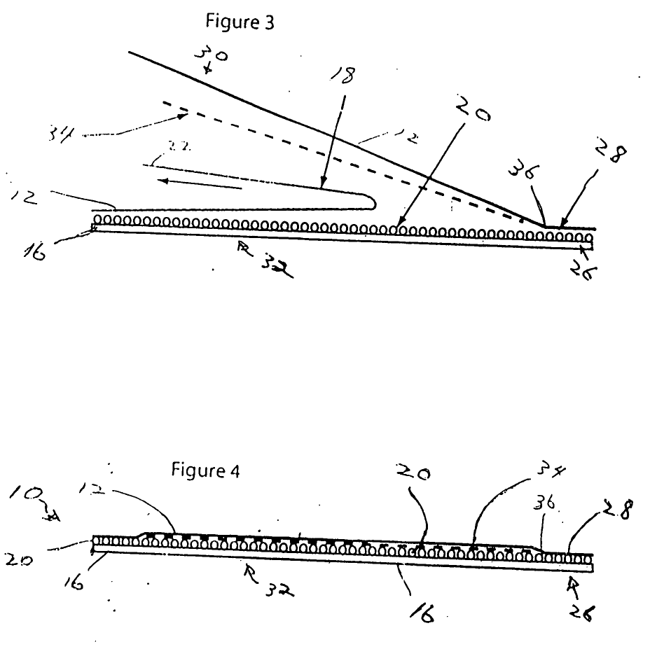

After the photograph 34 is inserted into the device 10, as shown in FIG. 2, the release liner 18 can be easily removed, as seen in FIG. 3. The tab 22 can be used to remove the release liner, or the release liner can be removed in any other desirable manner.

The photograph 34 is shown fully laminated in the device 10 in FIG. 4. Because the adhesive 20 is pressure sensitive, the laminate 12 can be easily adhered to the substrate 16. In other words, with the release liner 18 completely removed, the laminate can be sealed around the edges of the photograph 34. In this manner, the photograph 34 itself is adhered to the base layer 12 by the adhesive 20, and the photograph 34 is covered by the laminate 12.

The device 10 is also shown in FIGS. 5 through 8. The product 10 as obtained by a consumer is shown in FIG. 5, where it is apparent that the portion 30 of the laminate 12 can be lifted from the substrate 16 due to the intervening release liner 18. The hinge 36 can also be seen in FIG. 5, as can the manner in which the portion 28 is adhered along an edge of the substrate 16.

FIG. 6 illustrates insertion of the photograph 34 into the device 10. In this figure, it is apparent that the photograph 34 is inserted beneath the laminate 12, over the entire release liner 16, including the tab portion 22. While FIG. 6 shows the photograph 34 abutting the hinge 36, the photograph 34 could be spaced from the hinge 36, if desired. In any event, the release layer 18 is removed in the manner shown in FIG. 7. It is most easily removed by pulling the tab portion 22, but it could also removed from any other portion of the release liner.

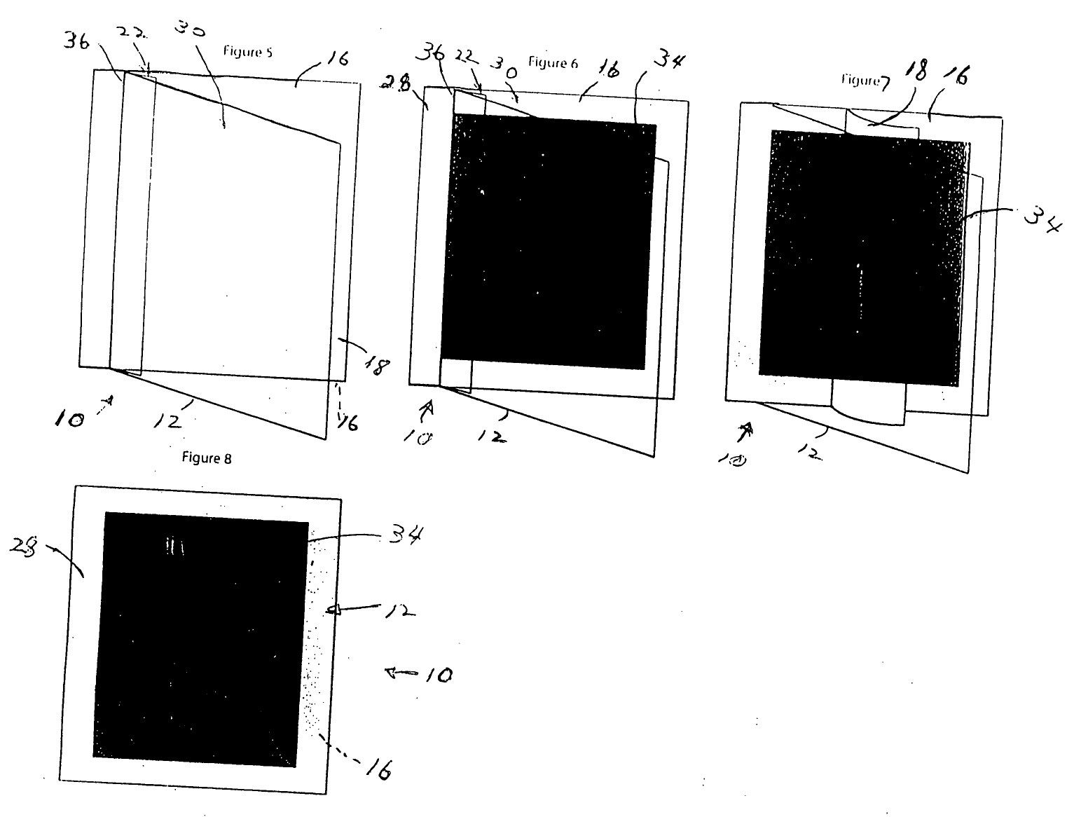

When the release liner 18 is removed, the laminate 12 can be easily adhered to the base layer 16, as seen in FIG. 8. The photograph 34 is also adhered to the base layer 16. It is apparent from FIG. 8 that the photograph 34 is smaller than the base layer 16, though, so that the laminate 12 is adhered around all of the outside edges of the photograph 34.

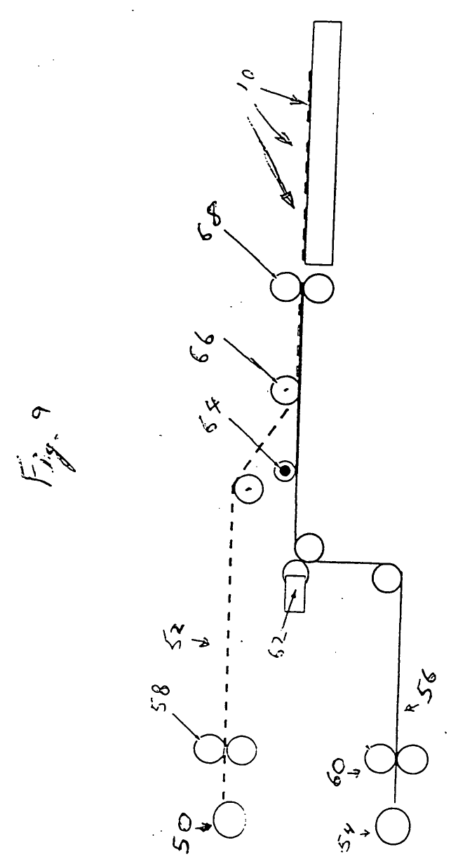

The process for manufacturing the lamination products 10 is illustrated in FIG. 9. A reel 50 of clear synthetic material such as polypropylene, vinyl or any other suitable material, is unrolled along a path 52, and a reel 54 of pressure sensitive material is unwound along a path 56. The pressure sensitive material 54 has one surface coated with a removable layer of release liner that when removed, exposes a layer of pressure sensitive adhesive.

The laminate 50 may be printed on one or both sides at one or more print stations 58, and the pressure sensitive material can also be printed, on one or both sides, at print stations 60.

The pressure sensitive material 54 is perforated and/or partially slit at a station 62, to allow the release liner to be folded back at a plow station 64. While the release liner is preferably folded back, as shown in FIGS. 1-8, it is contemplated that the release liner could be slit and the unwanted portion of the release liner removed.

The laminate 50 is adhered to the base substrate 54 at a station 66, which could be nip rollers or the like. The laminate 50 is adhered to the substrate 54 along the exposed edge of the substrate 54, and the remaining portion of the laminate rests un-adhered over the release liner. The married webs are die-cut at a station 68, producing the lamination products 10.

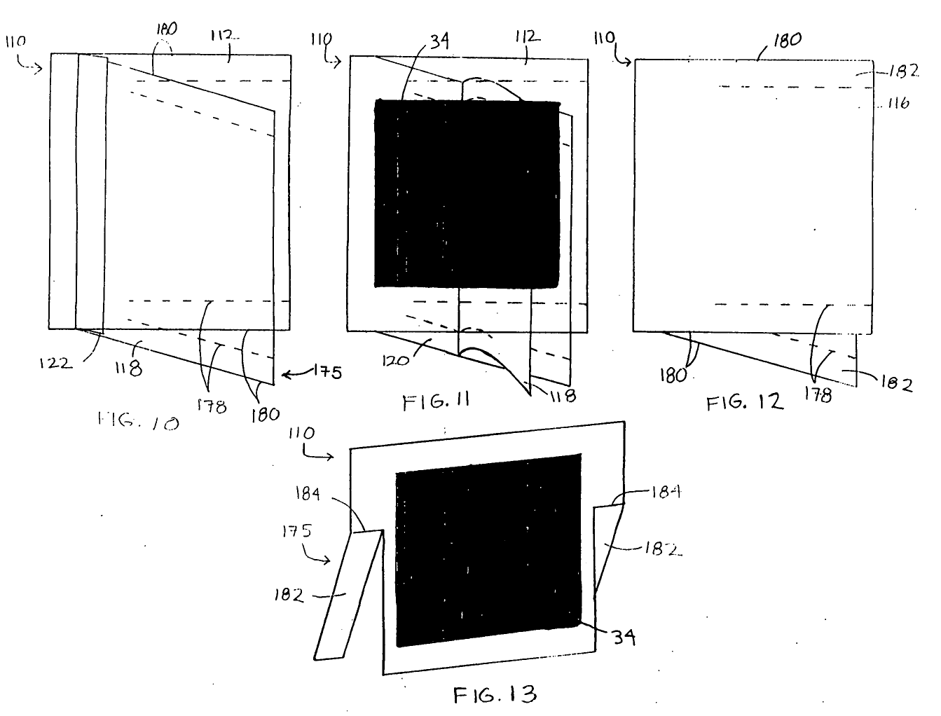

Referring now to FIGS. 10-13, an alternate embodiment of the present lamination product is generally designated 110 and is generally similar to the first embodiment 10 except that in addition to the features of the first embodiment, the alternate embodiment includes a support structure 175. Like components of lamination products 10 and 110 have been designated with the same last two digits in their reference numbers.

In this embodiment, the lamination product 110 includes a laminate layer 112 of unsupported film, a lower layer 116 of paper or film, a pressure sensitive adhesive layer 120, and a release layer 118. Each layer 112, 116, 118 and 120 is perforated along a perforated line 178 on at least one, but preferably two opposing edges 180 of the lamination product 110 such that, when the layers are assembled to form the lamination product, the perforation of the layers are aligned. As shown in FIG. 12, the perforated line 178 extends a length less than the total length of the opposing edges 180 and is inwardly located a predetermined length from the opposing edge to define at least one leg 182. Although the lamination product is shown with two perforated lines 178 that are parallel to the opposing edges 180, other numbers and alignments of perforated lines are contemplated. It is also contemplated that the perforated line may be die-cut instead of perforated.

After the photograph 34 is inserted into the lamination product 110, the release liner 118 can be removed, as shown in FIG. 11. The tab 122 may be used to remove the entire release liner 118. When the photograph 34 is adhered to the base layer 112 by the adhesive 120, the laminate 112 covers the photograph 34 and can be adhered to the base layer. The photograph 34 is preferably smaller than the base area between the legs 182, so that the laminate 112 is adhered around all of the outside edges of the photograph.

Upon laminating the photograph 34, the user may separate the perforations, such as by tearing or cutting along the perforated lines 178 on the now adhered layers 112, 116, and 120. The layers 112, 116, and 120 may be folded away from the rear surface of the product 110 to form the support structure 175, which includes the at least one leg 182 and a fold line 184, such that the lamination product 110 may be supported on a table or the like in an upright position by the legs 182.

The process for manufacturing the lamination product 110 is similar to the manufacturing process of lamination product 10, but also includes the step of perforating layers 112, 118, 120 and 116 along preferably two perforated lines. This step may occur either before or after the married webs are die-cut into individual lamination products 110.

Referring now to FIGS. 14-17, another alternate embodiment of the present lamination product is generally designated 210 and is generally similar to the first embodiment 10, except that in addition to the features of the first embodiment, the third embodiment includes an alternate support structure 275. Like components of lamination products 10, 110 and 210 have been designated with the same last two digits in their reference numbers.

In this embodiment, the lamination product 210 includes a laminate layer 212, a lower layer 216, a pressure sensitive adhesive layer 220, and a release layer 218. Layers 216, 218 and 220 are die-cut along preferably two first cut lines 278 at generally the center of the lamination product 210 such that, when the layers are assembled into the lamination product, the die-cuts of each layer are aligned with the other die-cuts. Cut lines 278 are preferably not continuous, but have a tear portion 281 located near the bottom edge. The two cut lines 278 may be parallel or skewed with respect to opposed edges 280.

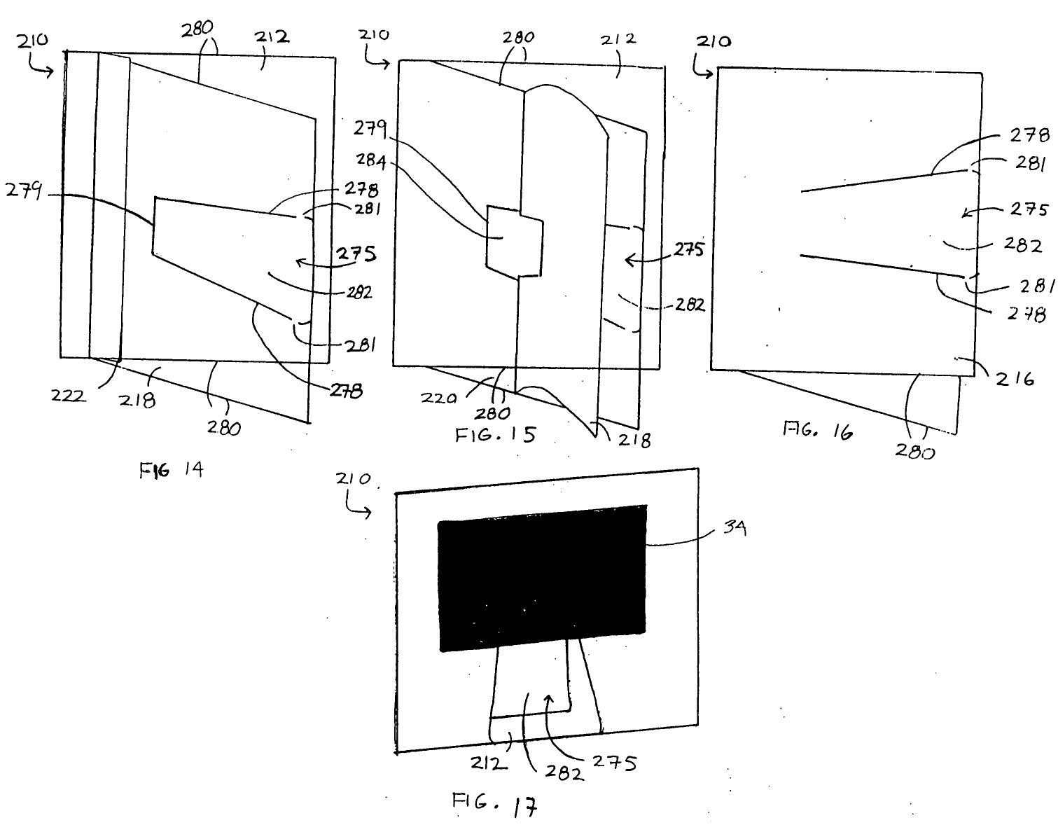

Release layer 218, but not lower layer 216 or adhesive layer 220, is also die cut to form a second cut line 279 at a location between the two cut lines 278 (best seen in FIGS. 15 and 16). The first cut lines 278 extend a length less than the total length of the opposing edges 280 and are inwardly located a length from the opposing edge. First cut lines 278 and second cut lines 279 intersect to define a leg 282. Although the lamination product is shown with first and second cut lines 278, 279 generally perpendicular to each other, other numbers and alignments of the die-cuts are contemplated. It is also contemplated that the cut lines may be perforated instead of die-cut.

In use, the release layer 218 can be removed by removing the tab 222. As shown in FIG. 15, the release layer 218 is removed from the pressure sensitive layer 220 except for over the area defined by the leg 282. Because only the release layer 218 is cut at cut line 279, a portion 284 of the release layer remains adhered.

When the photograph 34 is adhered to the base layer 212 by the exposed adhesive layer 220, or the area of adhesive layer outside of the leg 282, the laminate 212 covers the photograph 34 and can be adhered to the base layer. Upon laminating the photograph 34, the user may separate the tear portion, such as by tearing or cutting. The layers 216, and 218, and 220 may be folded along the second cut line 279 such that the leg 282 supports the lamination product 210.

Manufacturing the lamination product 210 is similar to manufacturing the lamination product 10, with the additional steps of die-cutting the release layer 218 along the second cut line 279, and die-cutting the release layer, the adhesive layer 220, and the lower layer 216 along the first cut line 278. In the preferred method of manufacturing, the release layer 218 is die-cut along the second cut line 279 before being adhered to the lower layer 216 with the adhesive layer 220. Similar to the first embodiment, when the reel of layers 218, 216, and 220 is unrolled, the layers can be perforated and/or partially slit at station 62. Additionally, layers 218, 216, and 220 can be die-cut along the first cut line 278 at station 62, although other processes are contemplated.

While the principles of the invention have been described above in connection with specific apparatus and applications, it is to be understood that this description is made only by way of example and not as a limitation on the scope of the invention.

What is claimed is:

1. A lamination product comprising
a substrate having pressure sensitive material on one side,
release material covering a first portion of the one side and exposing a second portion of the one side, and
a transparent laminate secured to the substrate by the exposed pressure sensitive adhesive, a portion of the laminate covering the first portion of the substrate and not being adhered to the substrate due to the release material,
whereby a photograph or other document can be secured in the lamination product by lifting the unadhered portion of the laminate, placing the photograph between the laminate and the substrate, removing the release layer to expose the pressure sensitive adhesive layer on the first portion of the substrate, and pressing the photograph and laminate against the exposed adhesive of the first portion.

2. The product of claim 1 wherein the photograph is smaller than the first portion of the substrate, so that the laminate is secured to the substrate around all outer edges of the photograph.

3. The product of claim 1 wherein the transparent laminate has printed matter on at least one of its outer edges.

4. The product of claim 1 wherein the release material is folded to expose the second portion.

5. The product of claim 1 further including a support structure having at least one leg defined by at least one perforated line that can be separated and folded to support the product.

6. The product of claim 5 wherein the release material has at least one perforated line which is aligned with the perforated line of the substrate.

7. The product of claim 1 wherein the substrate has at least one cut line defining a leg, wherein the leg is folded to support the lamination product.

8. The product of claim 7 wherein the substrate includes at least two layers having at least one first cut line, and one of the at least two layers having a second cut line whereby the first and the second cut lines intersect.

9. A method for manufacturing a lamination product comprising the steps of
moving a web of material along a path, the web having pressure sensitive adhesive on one side, the pressure sensitive adhesive being covered by release material,
exposing the pressure sensitive adhesive along an edge of the web,
adhering transparent laminate to the web where the pressure sensitive adhesive is exposed, the laminate also covering the release material, and
die cutting the web into individual lamination products having a desired size.

10. The method of claim 9 comprising the step of printing the transparent laminate on at least one of its outer edges.

11. The method of claim 9 wherein the exposed pressure sensitive adhesive is exposed by folding the release material.

12. The method of claim 9 comprising the step of perforating the substrate, the release material and the transparent laminate along at least one perforated line.

13. The method of claim 9 comprising the step of cutting the web and the release material at at least one first cut line.

14. The method of claim 13 comprising the step of cutting the release material at at least one second cut line, whereby the at least one first cut line and the at least one second cut line intersect.

15. A method for laminating a photograph or other document in a lamination product having
a substrate having pressure sensitive material on one side,
release material covering a first portion of the one side and exposing a second portion of the one side, and
a transparent laminate secured to the substrate by the exposed pressure sensitive adhesive, the portion of the laminate covering the first portion of the substrate and not being adhered to the substrate due to the release material, comprising the steps of:
placing the photograph between the laminate and the substrate,
removing the release layer to expose the pressure sensitive adhesive layer on the first portion of the substrate, and
pressing the photograph and laminate against the exposed adhesive of the first portion.

16. The method of claim 15 comprising the step of supporting the lamination product by separating perforations on the substrate and laminate which define a leg, and folding the leg.

17. The method of claim 15 comprising the step of removing the release layer wherein a portion of the release layer remains on the substrate.

18. The method of claim 17 comprising the step of supporting the lamination product by folding a leg defined by at least one cut line on the substrate and the release layer.

19. The method of claim 18 comprising the step of separating a tear portion disposed along at least one cut line on the substrate and the release layer.
